(19) United States
(12) Patent Application Publication
(10) Pub. No.: US 2024/0176034 A1
(43) Pub. Date: May 30, 2024

(54) PULSE SHAPE DISCRIMINATION TECHNIQUES FOR DUAL-MODE SCINTILLATOR DETECTORS

(71) Applicant: Radiation Monitoring Devices, Inc., Watertown, MA (US)

(72) Inventor: Andrey Gueorguiev, Burlington, MA (US)

(73) Assignee: Radiation Monitoring Devices, Inc., Watertown, MA (US)

(21) Appl. No.: 18/072,063

(22) Filed: Nov. 30, 2022

(51) Int. Cl. G01T 1/208; G01T 3/06

(52) U.S. Cl. CPC G01T 1/208; G01T 3/06

(57) ABSTRACT

An improved dual mode scintillator detector is described that performs pulse shape discrimination of incident neutrons and gamma rays. The detector may comprise a dual mode scintillator coupled to two shaping amplifiers with different shaping times. A luminescence signal produced by the scintillator will generally produce two different signals from the shaping amplifiers, and the relative amplitudes of these signals may allow for gamma-neutron discrimination. For instance, if the scintillator produces a luminescence signal over a shorter time period for one type of incident particle (e.g., gamma events) and produces a luminescence signal over a longer time period for the other type of incident particle (e.g., neutron events), the relative amplitudes of the signals produced by each shaping amplifier can allow for gamma-neutron discrimination.

### FIELD OF INVENTION

The present application relates generally to the use of pulse shaping techniques for a scintillator detector configured to discriminate between incident neutron and gamma ray particles.

### BACKGROUND

Scintillators are widely-used as detectors for spectroscopy of energetic photons (e.g. X-rays and gamma rays) as well as neutrons. These detectors are commonly used in nuclear and high energy physics research, medical imaging, diffraction, non-destructive testing, geological exploration, and other applications.

### SUMMARY

According to some aspects, a gamma-neutron detector is provided comprising a scintillator configured to produce a luminescence signal in response to incident gamma rays and neutrons, a first shaping amplifier, having a first shaping time, arranged to receive the luminescence signal produced by the scintillator and produce a first signal, a second shaping amplifier, having a second shaping time longer than the first shaping time, arranged to receive the luminescence signal produced by the scintillator and produce a second signal, a first window comparator arranged to produce a first logical output indicative of whether the first signal is within a first amplitude range, a second window comparator arranged to produce a second logical output indicative of whether the second signal is within a second amplitude range, different from the first amplitude range, and a logic analyzer arranged to determine whether the luminescence signal was produced by an incident gamma ray or an incident neutron based on the first and second logical outputs.

According to some aspects, a method is provided of discriminating between incident gamma rays and neutrons, the method comprising generating a luminescence signal using a scintillator in response to an incident gamma rays or neutron, generating a first signal based on the luminescence signal produced by the scintillator device using a first shaping amplifier having a first shaping time, generating a second signal based on the luminescence signal produced by the scintillator device using a second shaping amplifier having a second shaping time longer than the first shaping time, generating a first logical output indicative of whether the first signal is within a first amplitude range using a first window comparator, generating a second logical output indicative of whether the second signal is within a second amplitude range, different from the first amplitude range, using a second window comparator, and determining, using a logic analyzer, whether the luminescence signal was produced by an incident gamma ray or an incident neutron based on the first and second logical outputs.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts a schematic of an illustrative dual mode scintillator detector 100, according to some embodiments;

FIG. 2A depicts an illustrative pulse produced by a scintillator, according to some embodiments;

FIGS. 2B-2C depict signals produced by two shaping amplifiers using the same signal of FIG. 2A as an input, according to some embodiments;

FIGS. 3A-3B depict gamma and neutron detection events, respectively, according to some embodiments;

FIG. 4 depicts logical analysis of signals for discrimination between gamma rays and neutrons, according to some embodiments; and

FIG. 5 illustrates an example of a computing system environment on which aspects of the invention may be implemented.

### DETAILED DESCRIPTION

Some types of scintillators allow for a dual mode of operation, in which gamma rays and neutrons may be detected with a single scintillator material. This mode of operation may allow for a lower complexity instrument, in that a detector may detect radiation from a single luminescence signal, which may be identified as having being produced from a neutron or a gamma ray through suitable signal processing operations. Typically, the signal processing of luminescence signals produced from a dual-mode scintillator utilizes digital analyzers, field programmable gate arrays (FPGAs), digital signal processors (DSPs) and/or other digital devices to discriminate between neutrons and gamma rays.

It is often desirable to arrange a dual mode scintillator detector within a portable device for various applications, and digital signal processing within such a device may lead to an undesirable amount of power usage. For instance, a portable device comprising a digital analyzer that digitizes luminescence signals, determines the amplitudes, rise times, or the like of the digitized signals and determines whether the luminescence signal was produced by a gamma ray or a neutron, may require an undesirable amount of power for a portable device. Moreover, even in devices not intended for portability, digital signal analyzers may represent a complex and/or expensive component for a dual mode scintillator detector.

The inventors have recognized and appreciated an improved dual mode scintillator detector that performs pulse shape discrimination of incident neutrons and gamma rays. The detector may comprise a dual mode scintillator coupled to two shaping amplifiers with different shaping times. A luminescence signal produced by the scintillator will generally produce two different signals from the shaping amplifiers, and the relative amplitudes of these signals may allow for gamma-neutron discrimination. For instance, if the scintillator produces a luminescence signal over a shorter time period for one type of incident particle (e.g., gamma events) and produces a luminescence signal over a longer time period for the other type of incident particle (e.g., neutron events), the relative amplitudes of the signals produced by each shaping amplifier can allow for gamma-neutron discrimination. The shaping amplifiers may be implemented with analog components, leading to a simple, lightweight detector with comparatively low power consumption.

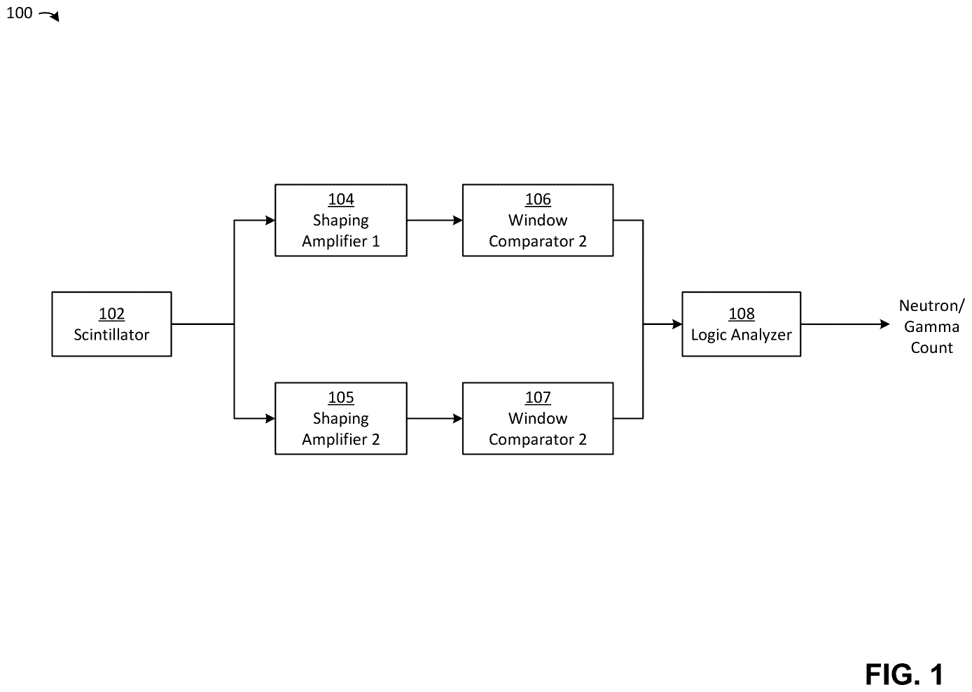

FIG. 1 depicts a schematic of an illustrative dual mode scintillator detector 100, according to some embodiments. As described further below, the shaping amplifiers 104 and 105, window comparators 106 and 107, and logic analyzer 108 of the illustrative detector 100 may each be implemented using analog or digital electronics, or a combination thereof. In some embodiments, however, it may be particularly advantageous for at least some of these elements to be implemented using analog components (either partially or entirely). For instance, in some embodiments the shaping amplifiers 104 and 105 may be implemented as analog components. In some embodiments, the detector 100 may comprise one or more analog to digital convertors to convert analog signals (e.g., the outputs of the shaping amplifiers 104 and 105) into digital signals (e.g., to be input to each of the window comparators 106 and 107).

In the example of FIG. 1, scintillator 102 comprises any suitable dual mode scintillator material configured to produce a luminescence signal in response to incident radiation that may include neutrons and/or gamma rays. While the term “gamma” or “gamma ray” may be used herein, it will be appreciated that this term is used to refer generally to incident electromagnetic radiation (photons) and the use of the term “gamma ray” is not intended to limit such radiation to particular energy ranges. For example, photons having energy in the x-ray or ultraviolet range of the electromagnetic spectrum may also be detectable in some embodiments using a dual mode detector described herein, as such a detector is not limited to detection of photons in any particular energy range (e.g., above 100 keV).

According to some embodiments, scintillator 102 may comprise an inorganic scintillator, such as an elpasolite scintillator. In some embodiments, the scintillator may comprise a Cs₂LiLn Halide composition. Ln may be selected from one or more of Y, La, Ce, Gd, Lu and Sc. The halide may comprise one or more of Cl, Br, I and F. In some cases, the halide comprises at least Cl. For instance, scintillator 102 may comprise Cs₂LiYCl₆ (CLYC) and/or Cs₂LiLa(Br,Cl)₆:Ce (CLLBC). It should be understood that other scintillator compositions may also be used.

Shaping amplifiers 104 and 105 may be configured to each receive the same luminescence signal produce by radiation incident on the scintillator 102, and to produce a respective output signal with an amplitude proportional to the total energy received over a predetermined time period. This time period, referred to herein as the “shaping time” for the shaping amplifier, relates to the time period over which the luminescence signal is integrated to produce the shaping amplifier output. As described above, shaping amplifiers 104 and 105 may have different shaping times, so that each shaping amplifier integrates the same luminescence signal over a different time period to produce different output signals. According to some embodiments, shaping amplifier 104 (“SA1”) may have a shorter shaping time than shaping amplifier 105 (“SA2”).

According to some embodiments, shaping amplifier 104 and/or shaping amplifier 105 may comprise a Gaussian shaping amplifier (also sometimes referred to as a pulse amplifier). According to some embodiments, shaping amplifier 104 and/or shaping amplifier 105 may comprise one or more operational amplifiers. According to some embodiments, shaping amplifier 104 and/or shaping amplifier 105 may comprise a CR-RC circuit, or a CR-RC-CR circuit.

According to some embodiments, the shaping time of shaping amplifier 104 is greater than or equal to 10 ns, 20 ns, 30 ns, 40 ns, 50 ns, 75 ns, 100 ns, 150 ns, 200 ns, or 300 ns. According to some embodiments, the shaping time of shaping amplifier 104 is less than or equal to 300 ns, 200 ns, 150 ns, 100 ns, 75 ns, 50 ns, 40 ns, 30 ns, or 20 ns. Any suitable combination of the above ranges are also possible (e.g., a shaping time of shaping amplifier 104 of greater than or equal to 50 ns and less than or equal to 200 ns).

According to some embodiments, the shaping time of shaping amplifier 105 is greater than or equal to 0.1 μs, 0.25 μs, 0.5 μs, 0.75 μs, 1.0 μs, 1.5 μs, 2.0 μs, 3.0 μs, 4.0 μs, 5.0 μs, 7.0 μs, or 10.0 μs. According to some embodiments, the shaping time of shaping amplifier 105 is less than or equal to 10.0 μs, 7.0 μs, 5.0 μs, 4.0 μs, 3.0 μs, 2.0 μs, 1.5 μs, 1.0 μs, 0.75 μs, 0.75 μs, 0.5 μs, or 0.25 μs. Any suitable combination of the above ranges are also possible (e.g., a shaping time of shaping amplifier 105 of greater than or equal to 1 us and less than or equal to 5 μs).

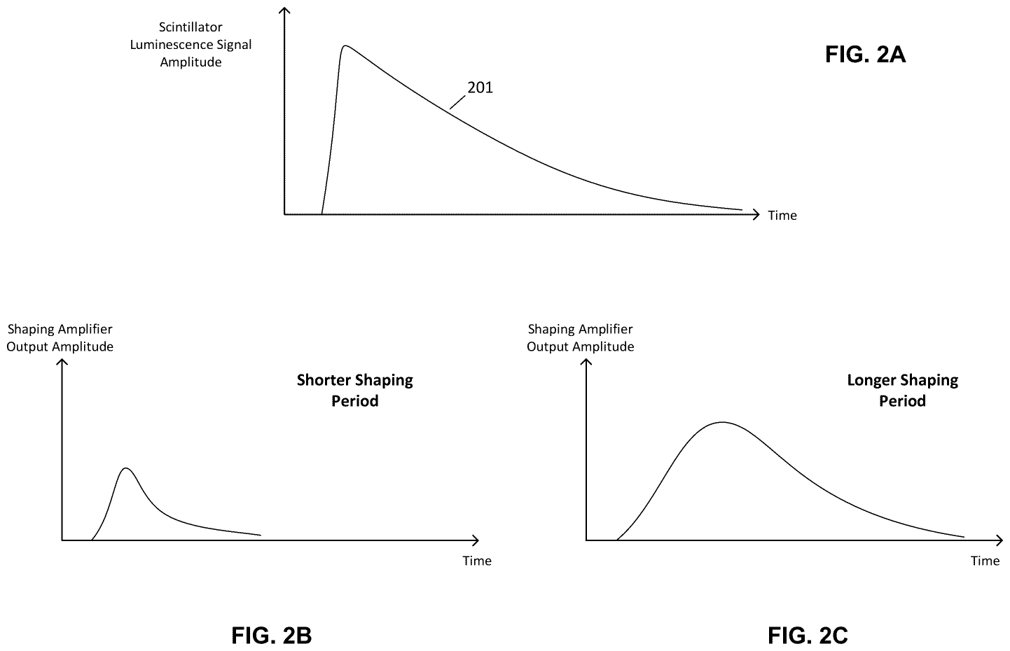

As an illustrative example of pulse shaping, FIG. 2A depicts an example pulse 201 produced by a scintillator. FIG. 2B and FIG. 2C depict the signals produced by two shaping amplifiers using the same signal 201 as an input, wherein FIG. 2B depicts the output of a shaping amplifier with a comparatively shorter shaping period, and FIG. 2C depicts the output of a shaping amplifier with a comparatively longer shaping period. As described above, if the scintillator produces a luminescence signal that lasts for a shorter time period for one type of incident particle than for the other, the relative amplitudes of the signals produced by each shaping amplifier can allow for particle type discrimination.

Returning to FIG. 1, window comparators 106 and 107 may be configured to receive the signals output from the shaping amplifiers 104 and 105, respectively, and output a signal indicating whether or not the maximum amplitude of the signals received are within a particular reference amplitude range. In some embodiments, the outputs of the window comparators may be an analog or digital signal indicating a logical 1 or 0 (e.g., high voltage indicating a maximum amplitude within the reference range, low voltage indicating a maximum amplitude not within the reference range)

In some embodiments, the window comparators may be analog components arranged to determine whether the maximum amplitude of an input signal falls within a range of reference levels (e.g., voltages). In some embodiments, the window comparators may be implemented digitally (e.g., in software) and configured to determine whether the maximum amplitude of an input signal falls within a range of reference levels. In this case, the detector 100 may comprise an analog-to-digital converter (ADC) arranged between the shaping amplifier 104 and window comparator 106, and an ADC arranged between the shaping amplifier 105 and window comparator 107, configured to produce digital signals from the outputs of the shaping amplifiers for digital analysis.

The range of reference levels of the two window comparators 106 and 107 may overlap (e.g., so the lower reference level for the range of one window comparator is lower than the higher reference level for the range of the other window comparator), or may be non-overlapping. In some embodiments, non-overlapping ranges may be preferable. According to some embodiments, the range of reference levels of the window comparator 107 may be higher than the range of reference levels of the window comparator 106. In some embodiments, shaping amplifier 104 may have a shorter shaping time than shaping amplifier 105 and the range of reference levels of the window comparator 106 may be lower than the range of reference levels of the window comparator 107.

According to some embodiments, window comparators 106 and/or window comparator 107 may comprise a pair of analog comparators and a logical AND gate. In this case, one of the analog comparators is configured to detect whether the input signal received by the window comparator is above a first reference voltage, and the other analog comparator is configured to detect whether the input signal received by the window comparator is below a second reference voltage. The outputs of the two comparators may be provided to the logical AND gate, which produces a logical output indicating whether the input signal received by the window comparator is between the first and second reference voltages (e.g., high voltage when the input signal received by the window comparator is between the first and second reference voltages, and a low voltage otherwise).

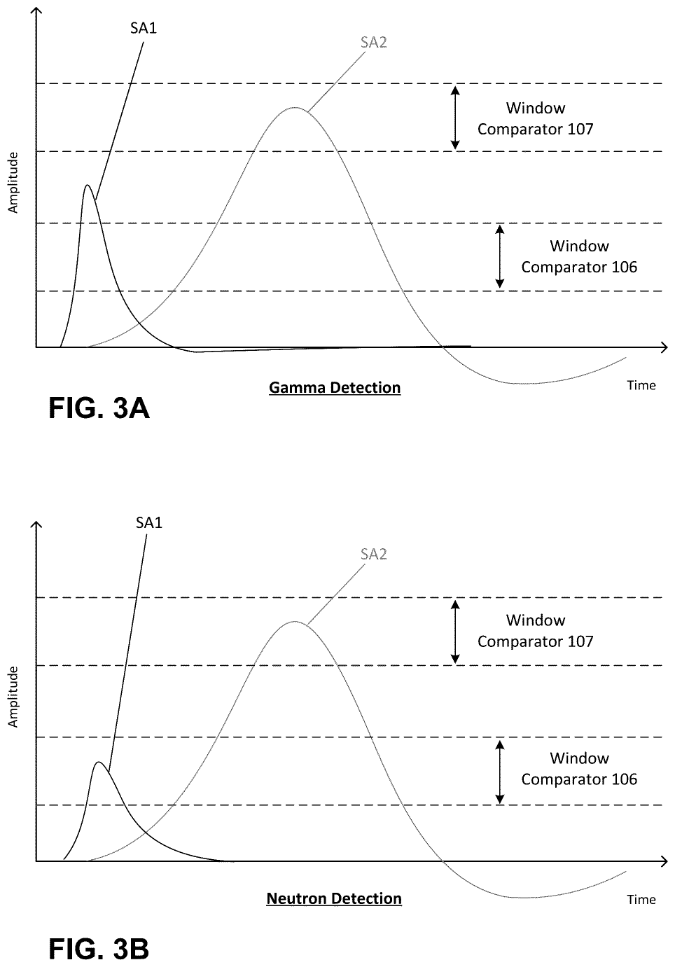

To further illustrate the use of the shaping amplifiers and window comparators of detector 100 to discriminate between gamma rays and neutrons, FIGS. 3A and 3B depict gamma and neutron detection events, respectively, according to some embodiments. In the example of FIG. 3A, the outputs of the shaping amplifier 104 (SA1) and shaping amplifier 105 (SA2) for an incident gamma ray are depicted. As may be noted, the SA2 maximum amplitude falls within the reference amplitude range for the window comparator 107, but the SA1 maximum amplitude does not fall within the reference amplitude range for the window comparator 106 (it may also be noted that the maximum amplitude also does not fall within the reference amplitude range for window comparator 107, although window comparator 107 is not involved in this analysis process). In contrast, in the example of FIG. 3B, which depicts an incident neutron event, the SA2 maximum amplitude falls within the reference amplitude range for the window comparator 107 and the SA1 maximum amplitude falls within the reference amplitude range for the window comparator 106.

In the case of an incident gamma ray, therefore, the window comparator 107 may output a signal indicating that the maximum amplitude of the signal received fell within its reference amplitude range, whereas the window comparator 106 may output a signal indicating that the maximum amplitude of the signal received did not fall within its reference amplitude range. For an incident neutron, the window comparator 107 may output a signal indicating that the maximum amplitude of the signal received fell within its reference amplitude range, and the window comparator 106 may also output a signal indicating that the maximum amplitude of the signal received fell within its reference amplitude range.

In some cases, an incident gamma ray of lower energy may produce an output from the shaping amplifier SA2 with a maximum amplitude that falls below the reference amplitude range of window comparator 107, including within the reference amplitude range of window comparator 106. However, only an incident neutron in this configuration will produce signals from the two shaping amplifiers that fall into both reference amplitude ranges of the window comparators. As such, the outputs of the window comparators provide a way to logically detect an incident neutron.

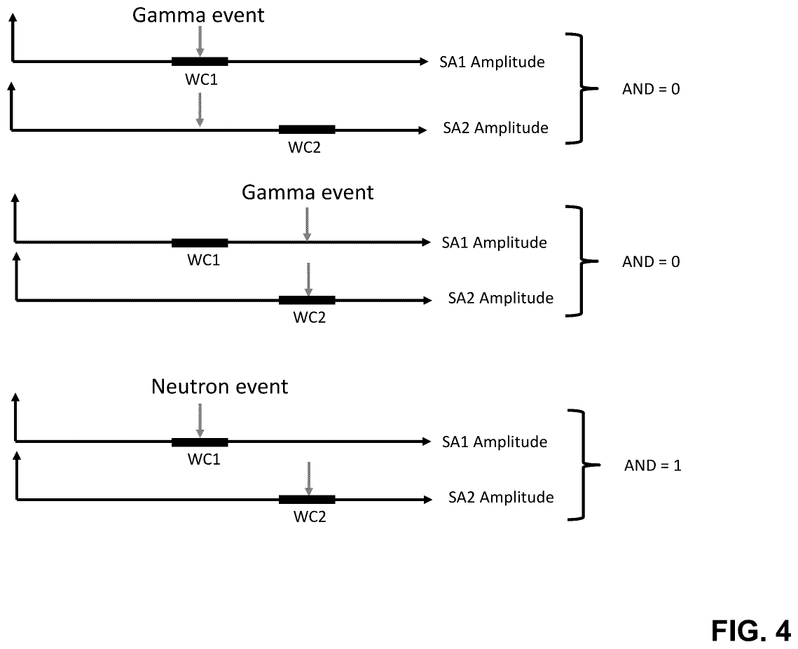

In particular, a logical AND operation may be performed by the logic analyzer 108 on the outputs of the two window comparators 106 and 107. An incident neutron will produce a logical 1 as an output (since both window comparators produced logical 1s), whereas an incident gamma will produce a logical 0 as an output (since at most only one of the window comparators produced a logical 1). This approach is also represented in FIG. 4, which depicts amplitudes of the shaping amplifier signals SA1 and SA2 on the horizontal axis. According to some embodiments, logic analyzer 108 may comprise an analog logic gate.

As a result of the above-described process of operating the shaping amplifiers 104 and 105, window comparators 106 and 107, and logic analyzer 108, the logic analyzer 108 may produce a signal indicating whether a luminescence signal produced by the scintillator 102 was produced by a gamma ray or a neutron. This signal may, for instance, be a high voltage (logical 1) when the luminescence signal was produced by a neutron, and a low voltage (logical 0) when the luminescence signal was produced by a gamma ray. However, the detector described is not limited to function in this manner, as other configurations may also be implemented.

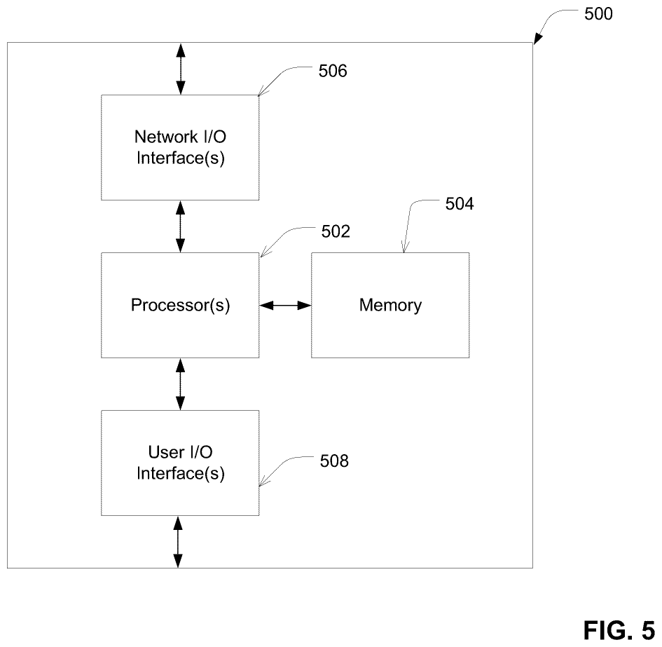

In some embodiments, systems and techniques described herein may be implemented using one or more computing devices. In particular, a computing device may be operated to act as any one or more of the elements 104, 105, 106, 107 or 108 of detector 100, including pulse shaping, detecting whether a pulse shaped signal falls between reference levels, and/or logical analysis of the outputs from window comparators, as described above. Embodiments are not, however, limited to operating with any particular type of computing device. By way of further illustration, FIG. 5 is a block diagram of an illustrative computing device 500. Computing device 500 may include one or more processors 502 and one or more tangible, non-transitory computer-readable storage media (e.g., memory 504). Memory 504 may store, in a tangible non-transitory computer-recordable medium, computer program instructions that, when executed, implement any of the above-described functionality. Processor(s) 502 may be coupled to memory 504 and may execute such computer program instructions to cause the functionality to be realized and performed.

Computing device 500 may also include a network input/output (I/O) interface 506 via which the computing device may communicate with other computing devices (e.g., over a network), and may also include one or more user I/O interfaces 508, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. As an example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In some embodiments, a software-based application may be connected (e.g., via a wired or wireless connection) to one or more components of a computing device. In certain embodiments, for example, the computing device 500 may be controlled, at least in part, by a software-based application. In some cases, a user may operate a graphical user interface to view results of gamma ray/neutron discrimination through the software-based application. In some cases, the software-based application may store information (e.g., counts of neutrons and gamma rays detected by detector 100).

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A gamma-neutron detector comprising:
a scintillator configured to produce a luminescence signal in response to incident gamma rays and neutrons;
a first shaping amplifier, having a first shaping time, arranged to receive the luminescence signal produced by the scintillator and produce a first signal;
a second shaping amplifier, having a second shaping time longer than the first shaping time, arranged to receive the luminescence signal produced by the scintillator and produce a second signal;
a first window comparator arranged to produce a first logical output indicative of whether the first signal is within a first amplitude range;
a second window comparator arranged to produce a second logical output indicative of whether the second signal is within a second amplitude range, different from the first amplitude range; and
a logic analyzer arranged to determine whether the luminescence signal was produced by an incident gamma ray or an incident neutron based on the first and second logical outputs.

2. The detector of claim 1, wherein the scintillator is an inorganic scintillator.

3. The detector of claim 2, wherein the scintillator is an elpasolite scintillator.

4. The detector of claim 3, wherein the scintillator comprises Cs₂LiYCl₆ (CLYC) and/or Cs₂LiLa(Br,Cl)₆:Ce (CLLBC).

5. The detector of claim 1, wherein the logic analyzer is configured to evaluate a logical AND operation on the first logical output and the second logical output.

6. The detector of claim 5, wherein the logic analyzer is configured to produce a signal indicating that the luminescence signal was produced by an incident gamma ray when the logical AND operation evaluates to 0, and wherein the logic analyzer is configured to produce a signal indicating that the luminescence signal was produced by an incident neutron when the logical AND operation evaluates to 1.

7. The detector of claim 1, wherein the second amplitude range is higher than the first amplitude range.

8. The detector of claim 1, wherein the first shaping time is between 50 ns and 200 ns, and wherein the second shaping time is between 1 μs and 3 μs.

9. A method of discriminating between incident gamma rays and neutrons, the method comprising:
generating a luminescence signal using a scintillator in response to an incident gamma rays or neutron;
generating a first signal based on the luminescence signal produced by the scintillator device using a first shaping amplifier having a first shaping time;
generating a second signal based on the luminescence signal produced by the scintillator device using a second shaping amplifier having a second shaping time longer than the first shaping time;
generating a first logical output indicative of whether the first signal is within a first amplitude range using a first window comparator;
generating a second logical output indicative of whether the second signal is within a second amplitude range, different from the first amplitude range, using a second window comparator; and
determining, using a logic analyzer, whether the luminescence signal was produced by an incident gamma ray or an incident neutron based on the first and second logical outputs.

10. The method of claim 9, wherein determining whether the luminescence signal was produced by an incident gamma ray or an incident neutron comprises evaluating a logical AND operation on the first logical output and the second logical output.

11. The method of claim 10, further comprising producing a signal indicating that the luminescence signal was produced by an incident gamma ray when the logical AND operation evaluates to 0.

12. The method of claim 10, further comprising producing a signal indicating that the luminescence signal was produced by an incident neutron when the logical AND operation evaluates to 1.

13. The method of claim 9, wherein the first shaping time is between 50 ns and 200 ns, and wherein the second shaping time is between 1 μs and 3 μs.

14. The method of claim 9, wherein the second amplitude range is higher than the first amplitude range.
